(19) United States
(12) Patent Application Publication
(10) Pub. No.: US 2007/0296114 A1
(43) Pub. Date: Dec. 27, 2007

(54) MANUFACTURING METHOD FOR RESIN JOINING PRODUCT, MOLDING DIE AND RESIN JOINING PRODUCT

(75) Inventors: YUICHIRO KITA, Nagano (JP); Kenichi Hayashi, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: NIDEC Sankyo Corporation

(21) Appl. No.: 11/758,208

(22) Filed: Jun. 5, 2007

(30) Foreign Application Priority Data
Jun. 22, 2006 (JP) 2006-173044

(51) Int. Cl. B28B 5/00

(52) U.S. Cl. 264/241; 425/500

(57) ABSTRACT

A manufacturing method for a resin joining product includes a molding step in which a first resin member and a second resin member are respectively formed with a molding die, and a joining step in which abutting faces of the first resin member and the second resin member are joined with each other. A molding face of the molding die for forming the abutting face may be provided with a protruded part for forming a recessed part on the abutting face, and an ejection pin is located at a position within an area of the protruded part. Alternatively, the ejection pin may be located on a side for forming a face on an opposite side to the abutting face. Alternatively, a protruded part may be formed on the abutting face to prevent liquid from leaking out.

### CROSS REFERENCE TO RELATED APPLICATION

The present invention claims priority under 35 U.S.C. §119 to Japanese Application No. 2006-173044 filed Jun. 22, 2006, which is incorporated herein by reference.

### BACKGROUND OF THE INVENTION

a) Field of the Invention

The present invention relates to a manufacturing method for a resin joining product which is structured of a first resin member and a second resin member which are joined with each other, a molding die used in the manufacturing method, and a resin joining product manufactured by the manufacturing method.

b) Description of the Related Art

In order to manufacture a resin joining product by joining a first resin member and a second resin member with each other, a molding step is performed in which each of the first resin member and the second resin member is molded with a molding die and then a joining step is performed in which respective abutting faces of the first resin member and the second resin member are joined with each other. In the joining step, a method utilizing an adhesive, a method using thermo-compression bonding, a method utilizing solvent bonding or the like may be used.

A method utilizing solvent bonding has been conventionally known in which, for example, in order to manufacture a resin joining product which is formed with a flow path in its inside, a recessed part such as a groove is formed on an abutting face of the first resin member, and solvent is interposed between abutting faces of the first resin member and the second resin member, and then the first resin member and the second resin member are pressurized to each other to join the first resin member with the second resin member (see, for example, Japanese Patent Laid-Open No. 2003-118000).

However, there are problems as described below in order to join resin members with each other which are manufactured by die molding.

For example, when a resin member is detached from a die member with an ejection pin at the time of die molding, a burr may be formed around a portion where the ejection pin is abutted. Therefore, when the resin members are joined with each other, a gap space due to the burr is formed between the resin members and thus the resin members cannot be joined with each other surely. Further, in a case that a protruded part is arranged on a die member for forming a through hole in the resin member, when the protruded part is extracted from the hole of the resin member, a burr may be formed on the extracted side of the resin member. Therefore, when the burr is sandwiched between the resin members, a gap space is formed between the resin members and thus the resin members cannot be joined with each other surely.

As a result, for example, when a flow path is formed in an abutting portion of a resin joining product for using as a biochip or the like, liquid leakage or the like may occur. On the other hand, when the burr is removed from the resin member by applying secondary processing with much labor, manufacturing cost increases and, even when deburring is performed, liquid leakage may still occur unless the burr has been completely removed.

### OBJECT AND SUMMARY OF THE INVENTION

In view of the problems described above, a primary object of the present invention is directed to providing a manufacturing method for a resin joining product which is capable of surely joining resin members with each other even when they are formed with a molding die, a molding die which is used in the manufacturing method, and a resin joining product which is manufactured by the manufacturing method.

Thus, in accordance with the present invention, a manufacturing method for a resin joining product comprises the steps of: a molding step in which a first resin member and a second resin member are respectively formed with a molding die; and a joining step in which an abutting face of the first resin member and an abutting face of the second resin member are joined with each other. In this manufacturing method, a molding face of a die member of the molding die, which is used in the molding step, for forming the abutting face of the first resin member or the second resin member is provided with a protruded part for forming a recessed part on the abutting face, and an ejection pin is located at a position within an area of the protruded part.

Further in accordance with the present invention, in the molding die, a molding face of a die member for forming the abutting face of the first resin member or the second resin member is provided with a protruded part for forming a recessed part on the abutting face, and an ejection pin is located at a position within an area of the protruded part.

According to the above method and structure, when a resin member is detached from the die member with the ejection pin, a pressing trace of the ejection pin is formed as a burr on the resin member, but the burr is formed inside of the recessed part of the resin member. Therefore, even when the burr is formed, a gap space is not formed between the first resin member and the second resin member and thus the first resin member and the second resin member can be joined with each other surely. In this case, a height of the protruded part for forming the recessed part is preferably formed higher than a height of the burr in consideration of the height of the burr which may be formed by the ejection pin.

Still further in accordance with the present invention, a manufacturing method for a resin joining product comprises the steps of: a molding step in which a first resin member and a second resin member are respectively formed with a molding die; and a joining step in which abutting faces of the first resin member and the second resin member are joined with each other. In this manufacturing method, an ejection pin is located on a side of a die member of the molding die for forming a face on an opposite side to the abutting face of the first resin member or the second resin member.

In accordance with this aspect of the present invention, in the molding die, an ejection pin is located on a side of a die member for forming a face on an opposite side to the abutting face of the first resin member or the second resin member.

Thus, according to this aspect of the invention, when the resin member is detached from the die member with the ejection pin, a pressing trace due to the ejection pin is formed as a burr on the resin member, but the burr is formed on the face on the opposite side to the abutting face of the resin member. Therefore, a gap space is not formed between the first resin member and the second resin member even when the burr is formed and thus the first resin member and the second resin member are surely joined with each other.

In accordance with another aspect of the present invention, a manufacturing method for a resin joining product comprises the steps of: a molding step in which a first resin member having an abutting face and a second resin member having an abutting face are respectively formed with a molding die, and in which a through hole that is opened to the abutting face of the first resin member or the second resin member is formed with the molding die; and a joining step in which an abutting face of the first resin member and an abutting face of the second resin member are joined to each other. In the molding die used in this manufacturing method, a die member is provided with a protruded part for forming the through hole on a molding face which forms a face on an opposite side to the abutting face.

In accordance with this aspect of the present invention, a die member of a molding die for manufacturing a first resin member having an abutting face and a second resin member having an abutting face is provided with a protruded part for forming the through hole on a molding face which forms a face on an opposite side to the abutting face.

Thus, according to this aspect of the invention, since the protruded part is provided on the die member to form the through hole in the resin member, a burr may be formed on an extracted side when the protruded part is extracted from a hole of the resin member. However, the burr is formed on the face on the opposite side to the abutting face of the resin member. Therefore, a gap space is not formed between the first resin member and the second resin member even when the burr is formed and thus the first resin member and the second resin member are surely joined with each other.

In accordance with yet another aspect of the present invention, a manufacturing method for a resin joining product comprises the steps of: a molding step in which a first resin member and a second resin member are respectively formed with a molding die; and a joining step in which an abutting face of the first resin member and an abutting face of the second resin member are joined with each other. In the molding step of this manufacturing method, a recessed part comprising of a groove and/or through holes is formed on the abutting face of at least one of the first resin member and the second resin member, and a protruded part surrounding the recessed part is formed on the one of the first resin member and the second resin member, or a protruded part surrounding an area which overlaps the recessed part is formed on the other of the first resin member and the second resin member.

Thus, according to this aspect of the invention, even when a burr is formed on the abutting face side of a resin member, the first resin member and the second resin member are joined with each other through the protruded part which is provided around the recessed part comprising of the groove and/or the through holes and thus the first resin member and the second resin member can be joined with each other surely.

In this case, the protruded part may be formed by using a groove formed on a molding face of the molding die which is used in the molding step.

In accordance with a still further aspect of the present invention, a first die member is provided with a protruded part for forming a recessed part comprising of a groove and/or through holes on the abutting face of at least one of the first resin member and the second resin member, and the first die member is provided with a groove surrounding the protruded part for forming the recessed part, or a second die member is provided with a groove surrounding an area which overlaps the recessed part on the abutting face that is formed by the protruded part of the first die member.

According to this aspect of the invention, when the first resin member and the second resin member overlap each other, the protruded part is surely structured around the recessed part comprising of the groove and the through holes and thus the first resin member and the second resin member are surely joined with each other even when the burr is formed on the abutting face side.

In a form of the invention, the protruded part may be made by utilizing a burr that is formed in the molding step.

According to this construction, a burr is utilized as the protruded part which is formed in a protruded shape so as to surround the recessed part completely. In this case, the first resin member and the second resin member are joined with each other through the burr and thus the first resin member and the second resin member are joined with each other surely.

In accordance with one form of the invention, a first die member is provided with a protruded part for forming a recessed part comprising of a groove and/or through holes on the abutting face of at least one of the first resin member and the second resin member, and the first die member is structured so that a burr is formed in a protruded shape so as to completely surround the recessed part, or a second die member is structured so that a burr is formed in a protruded shape so as to completely surround an area which overlaps the recessed part on the abutting face that is formed by the protruded part of the first die member.

According to the structure as described above, even when a burr is formed on the abutting face of the resin member, the first resin member and the second resin member are joined with each other by utilizing the burr and thus the first resin member and the second resin member can be joined with each other surely.

In accordance with another aspect of the invention, in the joining step, solvent bonding may be utilized in which solvent is interposed between the first resin member and the second resin member, and the first resin member and the second resin member are pressed with each other.

In the present invention, the various aspects and structures may be utilized separately but a combination of them may also be utilized.

According to the present invention, even when a burr is formed when resin members are formed by using a molding die, the first resin member and the second resin member are joined with each other surely. Therefore, even when a flow path is formed in the abutting face of a resin joining product to be used as a biochip, liquid leakage or the like does not occur. Accordingly, secondary processing with much labor is not required and, even when a burr is left after deburring has been performed, occurrence of liquid leakage can be prevented surely.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

In the drawings:

FIG. 1(a) is an explanatory view showing a structure of a resin joining product in accordance with a first embodiment of the present invention, FIG. 1(b) is a cross-sectional view showing a first resin member which is used for manufacturing the resin joining product, FIG. 1(c) is an explanatory view showing a molding die which is used for manufacturing the first resin member, FIG. 1(d) is a cross-sectional view showing a second resin member which is used for manufacturing the resin joining product, and FIG. 1(e) is an explanatory view showing a molding die which is used for manufacturing the second resin member.

FIG. 2(a) is an explanatory view showing a structure of a resin joining product in accordance with a modified example of the first embodiment of the present invention, FIG. 2(b) is a cross-sectional view showing a first resin member which is used for manufacturing the resin joining product, FIG. 2(c) is an explanatory view showing a molding die which is used for manufacturing the first resin member, FIG. 2(d) is a cross-sectional view showing a second resin member which is used for manufacturing the resin joining product, and FIG. 2(e) is an explanatory view showing a molding die which is used for manufacturing the second resin member.

FIG. 3(a) is an explanatory view showing a structure of a resin joining product in accordance with a second embodiment of the present invention, FIG. 3(b) is a cross-sectional view showing a first resin member which is used for manufacturing the resin joining product, FIG. 3(c) is an explanatory view showing a molding die which is used for manufacturing the first resin member, FIG. 3(d) is a cross-sectional view showing a second resin member which is used for manufacturing the resin joining product, and FIG. 3(e) is an explanatory view showing a molding die which is used for manufacturing the second resin member.

FIG. 4(a) is an explanatory view showing a structure of a resin joining product in accordance with a modified example of the second embodiment of the present invention, FIG. 4(b) is a cross-sectional view showing a first resin member which is used for manufacturing the resin joining product, FIG. 4(c) is an explanatory view showing a molding die which is used for manufacturing the first resin member, FIG. 4(d) is a cross-sectional view showing a second resin member which is used for manufacturing the resin joining product, and FIG. 4(e) is an explanatory view showing a molding die which is used for manufacturing the second resin member.

FIG. 5(a) is an explanatory view showing a structure of a resin joining product in accordance with a third embodiment of the present invention, FIG. 5(b) is a cross-sectional view showing a first resin member which is used for manufacturing the resin joining product, FIG. 5(c) is an explanatory view showing a molding die which is used for manufacturing the first resin member, FIG. 5(d) is a cross-sectional view showing a second resin member which is used for manufacturing the resin joining product, and FIG. 5(e) is an explanatory view showing a molding die which is used for manufacturing the second resin member.

FIG. 6(a) is an explanatory view showing a structure of a resin joining product in accordance with a modified example of the third embodiment of the present invention, FIG. 6(b) is a cross-sectional view showing a first resin member which is used for manufacturing the resin joining product, FIG. 6(c) is an explanatory view showing a molding die which is used for manufacturing the first resin member, FIG. 6(d) is a cross-sectional view showing a second resin member which is used for manufacturing the resin joining product, and FIG. 6(e) is an explanatory view showing a molding die which is used for manufacturing the second resin member.

FIG. 7(a) is an explanatory view showing a structure of a resin joining product in accordance with a fourth embodiment of the present invention, FIG. 7(b) is a cross-sectional view showing a first resin member which is used for manufacturing the resin joining product, FIG. 7(c) is an explanatory view showing a molding die which is used for manufacturing the first resin member, FIG. 7(d) is a cross-sectional view showing a second resin member which is used for manufacturing the resin joining product, and FIG. 7(e) is an explanatory view showing a molding die which is used for manufacturing the second resin member.

FIG. 8(a) is an explanatory view showing a structure of a resin joining product in accordance with a modified example of the fourth embodiment of the present invention, FIG. 8(b) is a cross-sectional view showing a first resin member used for manufacturing of this resin joining product, FIG. 8(c) is an explanatory view showing a molding die which is used for manufacturing the first resin member, FIG. 8(d) is an cross-sectional view showing a second resin member which is used for manufacturing the resin joining product, and FIG. 8(e) is an explanatory view showing a molding die which is used for manufacturing the second resin member.

FIG. 9(a) is an explanatory view showing a structure of a resin joining product in accordance with another modified example of the fourth embodiment of the present invention, FIG. 9(b) is a cross-sectional view showing a first resin member which is used for manufacturing the resin joining product, FIG. 9(c) is an explanatory view showing a molding die which is used for manufacturing the first resin member, FIG. 9(d) is a cross-sectional view showing a second resin member which is used for manufacturing the resin joining product, and FIG. 9(e) is an explanatory view showing a molding die which is used for manufacturing the second resin member.

FIG. 10(a) is an explanatory view showing a structure of a resin joining product in accordance with further another modified example of the fourth embodiment of the present invention, FIG. 10(b) is a cross-sectional view showing a first resin member which is used for manufacturing the resin joining product, FIG. 10(c) is an explanatory view showing a molding die which is used for manufacturing the first resin member, FIG. 10(d) is a cross-sectional view showing a second resin member which is used for manufacturing the resin joining product, and FIG. 10(e) is an explanatory view showing a molding die which is used for manufacturing the second resin member.

FIG. 11(a) is an explanatory view showing a structure of a resin joining product in accordance with a fifth embodiment of the present invention, FIG. 11(b) is a cross-sectional view showing a first resin member which is used for manufacturing the resin joining product, FIG. 11(c) is an explanatory view showing a molding die which is used for manufacturing the first resin member, FIG. 11(d) is a cross-sectional view showing a second resin member which is used for manufacturing the resin joining product, and FIG. 11(e) is an explanatory view showing a molding die which is used for manufacturing the second resin member.

### DETAILED DESCRIPTION OF THE PREFERRED EMBODIMENTS

A resin joining product, a manufacturing method for the resin joining product and a molding die used in the manufacturing method in accordance with an embodiment of the present invention will be described below with reference to the accompanying drawings.

### First Embodiment

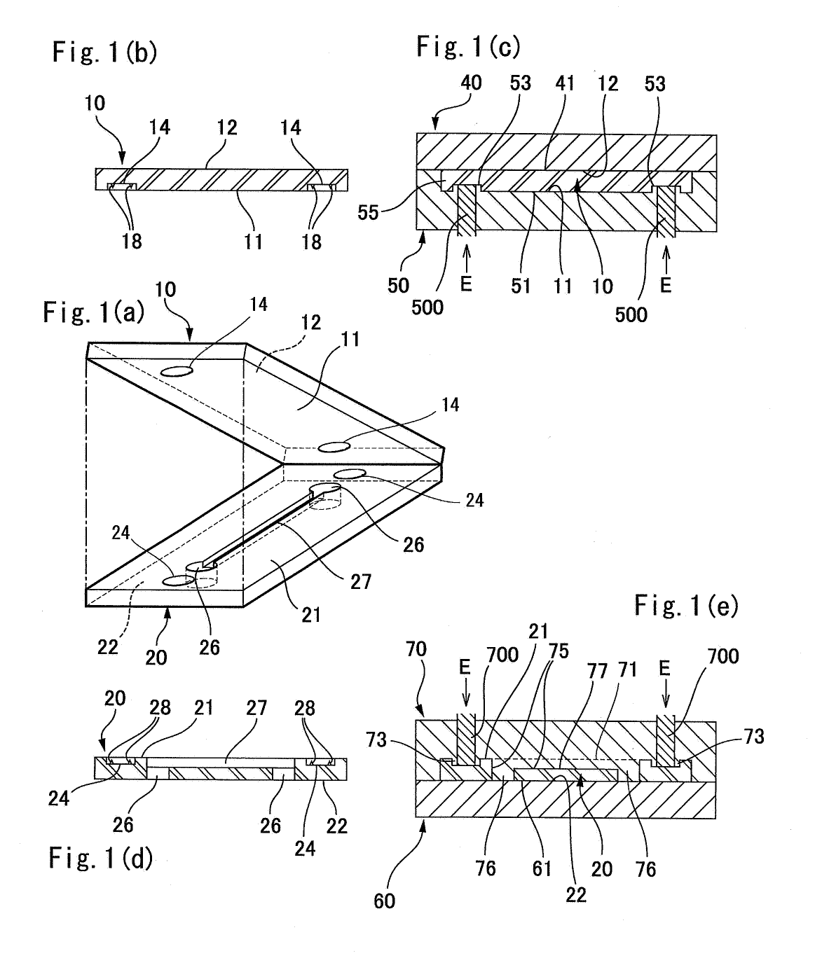

FIG. 1(a) is an explanatory view showing a structure of a resin joining product in accordance with a first embodiment of the present invention, FIG. 1(b) is a cross-sectional view showing a first resin member which is used for manufacturing the resin joining product, FIG. 1(c) is an explanatory view showing a molding die which is used for manufacturing the first resin member, FIG. 1(d) is a cross-sectional view showing a second resin member which is used for manufacturing the resin joining product, and FIG. 1(e) is an explanatory view showing a molding die which is used for manufacturing the second resin member.

As shown in FIG. 1(a), a resin joining product in accordance with the first embodiment is manufactured such that, in a molding step, a first resin member 10 and a second resin member 20 which are formed of acrylic plate or the like are molded with a molding die and then, in a joining step, solvent whose viscosity is 10 mPa/s or less, for example, propyl alcohol is interposed between an abutting face 11 of the first resin member 10 and an abutting face 21 of the second resin member 20 and, in this state, the first resin member 10 and the second resin member 20 are pressurized to each other while heated to, for example, 45 degrees Celsius for 10 minutes. As a result, the resin joining product in accordance with the first embodiment is obtained by joining the abutting faces 11 and 21 of the first resin member 10 and the second resin member 20 with each other by solvent bonding.

As shown in FIGS. 1(a) and 1(b), the abutting face 11 of the first resin member 10 is a flat surface on which a groove or the like is not formed. On the other hand, as shown in FIGS. 1(a) and 1(d), the abutting face 21 of the second resin member 20 is formed with a recessed part comprising a groove 27 with a width of 200 μm and a depth of 200 μm and through holes 26 whose bore diameter is 5 mm. Therefore, when the abutting faces 11 and 21 of the first resin member 10 and the second resin member 20 are joined with each other by solvent bonding, a flow path formed of the groove 27 is structured in the joining interface and sample injection ports communicating with the flow path are structured in the second resin member 20 with the through holes 26.

In order to manufacture the resin joining product as described above, in a manufacturing process (molding step) of the first resin member 10, as shown in FIG. 1(c), a molding die provided with a first die member 40 and a second die member 50 are used. The first die member 40 is provided with a flat molding face 41 for molding a face 12 on an opposite side to the abutting face 11 of the first resin member 10. The second die member 50 is provided with a molding face 51 for molding the abutting face 11 of the first resin member 10 on a bottom part of a cavity portion 55.

In accordance with the first embodiment, ejection pins 500 are arranged on a side of the second die member 50 and, when the first resin member 10 is to be detached from the second die member 50, the ejection pins 500 are moved as shown by the arrow “E” and their tip end portions abut with the first resin member 10. Accordingly, a burr 18 as shown in FIG. 1(b) may be formed on the first resin member 10 due to a gap space between a hole of the second die member 50 and the ejection pin 500 or due to a pressing trace of the ejection pin 500. However, in the first embodiment, a protruded part 53 is formed on the molding face 51 of the second die member 50 and the ejection pin 500 is disposed within a formed area of the protruded part 53. Therefore, a recessed part 14 is formed on the abutting face 11 of the first resin member 10 by the protruded part 53 and thus the burr 18 is formed on the bottom face of this recessed part 14. A depth dimension of the recessed part 14 is set so that the burr 18 is accommodated within the recessed part 14 and is not protruded from the recessed part 14 even when the burr 18 is formed on the bottom face of the recessed part 14.

Further, in a manufacturing process (molding step) of the second resin member 20, as shown in FIG. 1(e), a molding die provided with a first die member 60 and a second die member 70 are used. The first die member 60 is provided with a flat molding face 61 for molding a face 22 on an opposite side to the abutting face 21 of the second resin member 20. The second die member 70 is provided with a molding face 71 for molding the abutting face 21 of the second resin member 20 on a bottom part of a cavity portion 75. In addition, the molding face 71 of the second die member 70 is formed with a low protruded part 77 for forming the groove 27 which is linearly extended and bar-shaped high protruded parts 76 for forming the through holes 26.

In accordance with the first embodiment, ejection pins 700 are arranged on a side of the second die member 70 and, when the second resin member 20 is to be detached from the second die member 70, the ejection pins 700 are moved as shown by the arrow “E” and their tip end portions abut with the second resin member 20. Accordingly, a burr 28 as shown in FIG. 1(d) may be formed on the second resin member 20 due to a gap space between a hole of the second die member 70 and the ejection pin 700 or due to a pressing trace of the ejection pin 700. However, in the first embodiment, a protruded part 73 is formed on the molding face 71 of the second die member 70 and the ejection pin 700 is disposed within a formed area of the protruded part 73. Therefore, a recessed part 24 is formed on the abutting face 21 of the second resin member 20 by the protruded part 73 and thus the burr 28 is formed on the bottom face of this recessed part 24. A depth dimension of the recessed part 24 is set so that the burr 28 is accommodated within the recessed part 24 and is not protruded from the recessed part 24 even when the burr 28 is formed on the bottom face of the recessed part 24.

As described above, in the first embodiment, even when the burrs 18 and 28 are formed on the first resin member 10 and the second resin member 20, the burrs 18 and 28 are formed on the bottom faces of the recessed parts 14 and 24. Therefore, even when the burrs 18 and 28 are formed, a gap space due to the burrs 18 and 28 is not formed between the first resin member 10 and the second resin member 20 and thus the first resin member 10 and the second resin member 20 are surely joined with each other. Therefore, liquid does not leak from the flow path which is formed with the groove 27.

### Modified Example of the First Embodiment

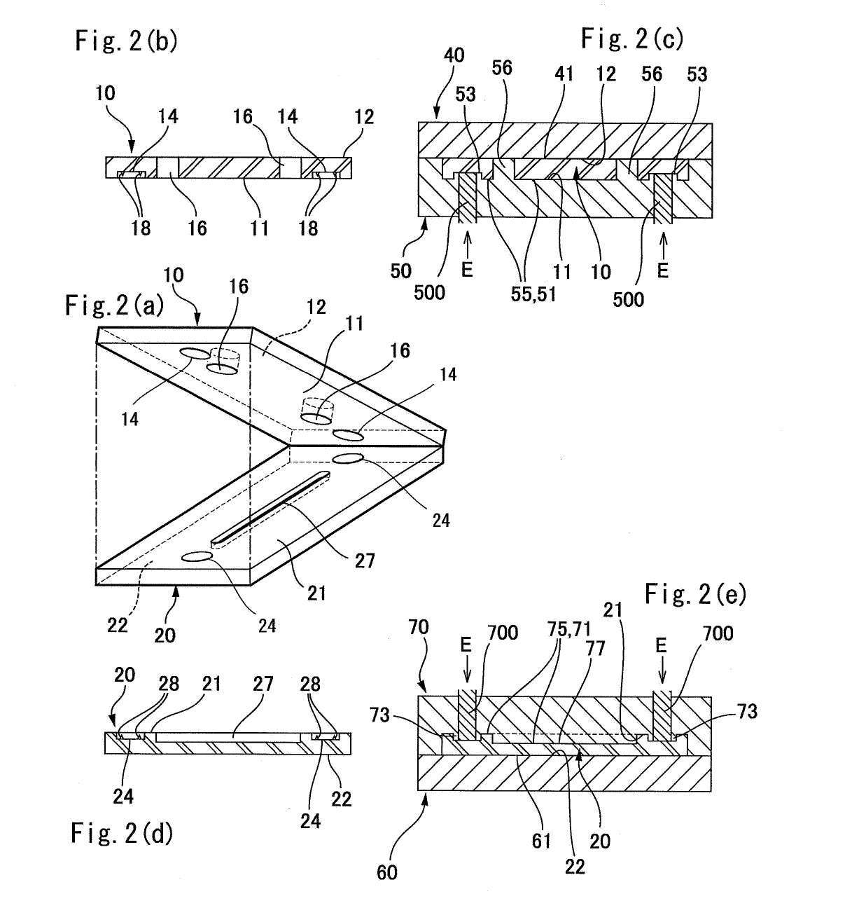

FIG. 2(a) is an explanatory view showing a structure of a resin joining product in accordance with a modified example of the first embodiment of the present invention, FIG. 2(b) is a cross-sectional view showing a first resin member which is used for manufacturing the resin joining product, FIG. 2(c) is an explanatory view showing a molding die which is used for manufacturing the first resin member, FIG. 2(d) is a cross-sectional view showing a second resin member which is used for manufacturing the resin joining product, and FIG. 2(e) is an explanatory view showing a molding die which is used for manufacturing the second resin member. Basic structures of this embodiment and another embodiments described below are similar to the first embodiment and thus the same notational symbols are used to portions common to the first embodiment and their descriptions are omitted.

As shown in FIG. 2(a), similarly to the first embodiment, a resin joining product of this embodiment is manufactured such that, in a molding step, a first resin member 10 and a second resin member 20 which are formed of acrylic plate or the like are molded with a molding die and then, in a joining step, solvent such as propyl alcohol is interposed between an abutting face 11 of the first resin member 10 and an abutting face 21 of the second resin member 20 and, in this state, the first resin member 10 and the second resin member 20 are heated and pressurized. As a result, the resin joining product in this embodiment. is obtained by joining the abutting faces 11 and 21 of the first resin member 10 and the second resin member 20 with each other by solvent bonding.

In this embodiment, as shown in FIGS. 2(a), 2(b) and 2(d), the recessed parts comprising of the through holes 16 whose bore diameter is 5 mm are formed in the first resin member 10 and the through holes 16 are opened to the abutting face 11. On the other hand, the abutting face 21 of the second resin member 20 is formed with a recessed part comprising a groove 27 with a width of 200 μm and a depth of 200 μm. Therefore, when the abutting faces 11 and 21 of the first resin member 10 and the second resin member 20 are joined with each other by solvent bonding, a flow path formed of the groove 27 is structured in the joining interface and sample injection ports communicating with the flow path are structured in the first resin member 10 with the through holes 16.

In order to manufacture the resin joining product as described above, in a manufacturing process (molding step) of the first resin member 10, as shown in FIG. 2(c), a molding die provided with a first die member 40 and a second die member 50 are used. The first die member 40 is provided with a flat molding face 41 for molding a face 12 on an opposite side to the abutting face 11 of the first resin member 10. The second die member 50 is provided with a molding face 51 for molding the abutting face 11 of the first resin member 10 on a bottom part of a cavity portion 55. In addition, the molding face 51 of the second die member 50 is formed with bar-shaped high protruded parts 56 for forming the through holes 16.

In accordance with this embodiment, ejection pins 500 are arranged on a side of the second die member 50 and, when the first resin member 10 is to be detached from the second die member 50, the tip end portions of the ejection pins 500 abut with the first resin member 10. Accordingly, a burr 18 as shown in FIG. 2(b) may be formed on the first resin member 10. However, in this embodiment, a protruded part 53 is formed on the molding face 51 of the second die member 50 and the ejection pin 500 is disposed within a formed area of the protruded part 53. Therefore, a recessed part 14 is formed on the abutting face 11 of the first resin member 10 by the protruded part 53 and thus the burr 18 is formed on the bottom face of this recessed part 14 and accommodated within the recessed part 14.

Further, in a manufacturing process (molding step) of the second resin member 20, as shown in FIG. 2(e), a molding die provided with a first die member 60 and a second die member 70 are used. The first die member 60 is provided with a flat molding face 61 for molding a face 22 on an opposite side to the abutting face 21 of the second resin member 20. The second die member 70 is provided with a molding face 71 for molding the abutting face 21 of the second resin member 20 on a bottom part of a cavity portion 75. In addition, the molding face 71 of the second die member 70 is formed with a low protruded part 77 for forming the groove 27 which is linearly extended.

In this embodiment, ejection pins 700 are arranged on a side of the second die member 70 and, when the second resin member 20 is to be detached from the second die member 70, tip end portions of the ejection pins 700 abut with the second resin member 20. Accordingly, a burr 28 as shown in FIG. 2(d) may be formed on the second resin member 20. However, in this embodiment, a protruded part 73 is formed on the molding face 71 of the second die member 70 and the ejection pin 700 is disposed within a formed area of the protruded part 73. Therefore, a recessed part 24 is formed on the abutting face 21 of the second resin member 20 by the protruded part 73 and thus the burr 28 is formed on the bottom face of this recessed part 24 and accommodated within the recessed part 24.

As described above, in this embodiment, even when the burrs 18 and 28 are formed on the first resin member 10 and the second resin member 20, the burrs 18 and 28 are formed on the bottom faces of the recessed parts 14 and 24 and accommodated within the recessed parts 14 and 24. Therefore, even when the burrs 18 and 28 are formed, a gap space due to the burrs 18 and 28 is not formed between the first resin member 10 and the second resin member 20 and thus the first resin member 10 and the second resin member 20 are surely joined with each other.

### Second Embodiment

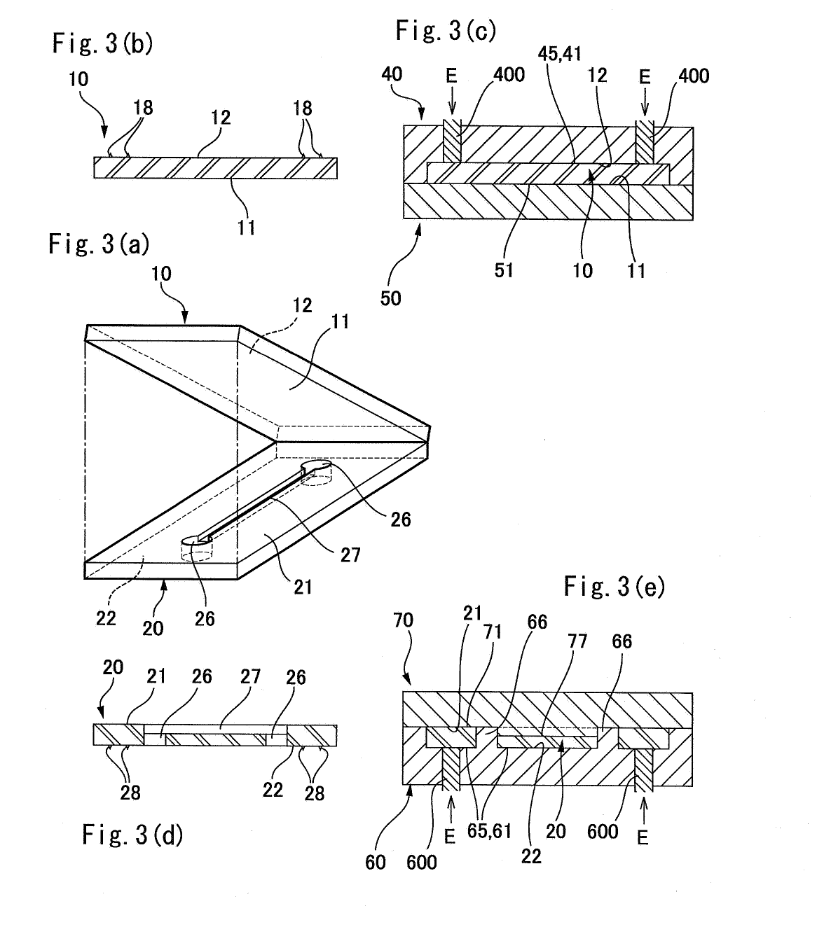

FIG. 3(a) is an explanatory view showing a structure of a resin joining product in accordance with a second embodiment of the present invention, FIG. 3(b) is a cross-sectional view showing a first resin member which is used for manufacturing the resin joining product, FIG. 3(c) is an explanatory view showing a molding die which is used for manufacturing the first resin member, FIG. 3(d) is a cross-sectional view showing a second resin member which is used for manufacturing the resin joining product, and FIG. 3(e) is an explanatory view showing a molding die which is used for manufacturing the second resin member.

As shown in FIG. 3(a), similarly to the first embodiment, a resin joining product of the second embodiment is manufactured such that, in a molding step, a first resin member 10 and a second resin member 20 which are formed of acrylic plate or the like are molded with a molding die and then, in a joining step, solvent such as propyl alcohol is interposed between an abutting face 11 of the first resin member 10 and an abutting face 21 of the second resin member 20 and, in this state, the first resin member 10 and the second resin member 20 are heated and pressurized. As a result, the resin joining product in the second embodiment is obtained by joining the abutting faces 11 and 21 of the first resin member 10 and the second resin member 20 with each other by solvent bonding.

As shown in FIGS. 3(a), 3(b) and 3(d), an abutting face 11 of the first resin member 10 is a flat surface on which a groove or the like is not formed. On the other hand, an abutting face 21 of the second resin member 20 is formed with a recessed part comprising of a groove 27 and through holes 26. Therefore, when the abutting faces 11 and 21 of the first resin member 10 and the second resin member 20 are joined with each other by solvent bonding, a flow path formed of the groove 27 is structured in the joining interface and sample injection ports communicating with the flow path are structured in the second resin member 20 with the through holes 26.

In order to manufacture the resin joining product as described above, in a manufacturing process (molding step) of the first resin member 10, as shown in FIG. 3(c), a molding die provided with a first die member 40 and a second die member 50 are used. The second die member 50 is provided with a flat molding face 51 for molding the abutting face 11 of the first resin member 10. The first die member 40 is provided with a molding face 41 for molding a face 12 on an opposite side to the abutting face 11 of the first resin member 10 on a bottom part of a cavity portion 45.

In accordance with the second embodiment, ejection pins 400 are arranged on a side of the first die member 40 and, when the first resin member 10 is to be detached from the first die member 40, the ejection pins 400 are moved as shown by the arrow “E” and their tip end portions abut with the face 12 on the opposite side to the abutting face 11 of the first resin member 10. Accordingly, a burr 18 as shown in FIG. 3(b) may be formed on the first resin member 10 but the burr 18 is formed on the face 12 on the opposite side to the abutting face 11.

Further, in a manufacturing process (molding step) of the second resin member 20, as shown in FIG. 3(e), a molding die provided with a first die member 60 and a second die member 70 are used. The first die member 60 is provided with a molding face 61 for molding a face 22 on an opposite side to the abutting face 21 of the second resin member 20 on a bottom part of a cavity portion 65. The second die member 70 is provided with a molding face 71 for molding the abutting face 21 of the second resin member 20. In addition, the molding face 71 of the second die member 70 is formed with a low protruded part 77 for forming the groove 27 which is linearly extended and the molding face 61 of the first die member 60 is formed with bar-shaped high protruded parts 66 for forming the through holes 26.

In accordance with the second embodiment, ejection pins 600 are arranged on a side of the first die member 60 and, when the second resin member 20 is to be detached from the first die member 60, the ejection pins 600 are moved as shown by the arrow “E” and their tip end portions abut with the face 22 on the opposite to the abutting face 21 of the second resin member 20. Accordingly, a burr 28 as shown in FIG. 3(d) may be formed on the second resin member 20 but the burr 28 is formed on the face 22 on the opposite side to the abutting face 21.

As described above, in the second embodiment, the burrs 18 and 28 are formed on the first resin member 10 and the second resin member 20 but the burrs 18 and 28 are formed on the faces 12 and 22 on the opposite side to the abutting faces 11 and 21. Therefore, a gap space due to the burrs 18 and 28 is not formed between the first resin member 10 and the second resin member 20 and thus the first resin member 10 and the second resin member 20 are surely joined with each other.

### Modified Example of the Second Embodiment

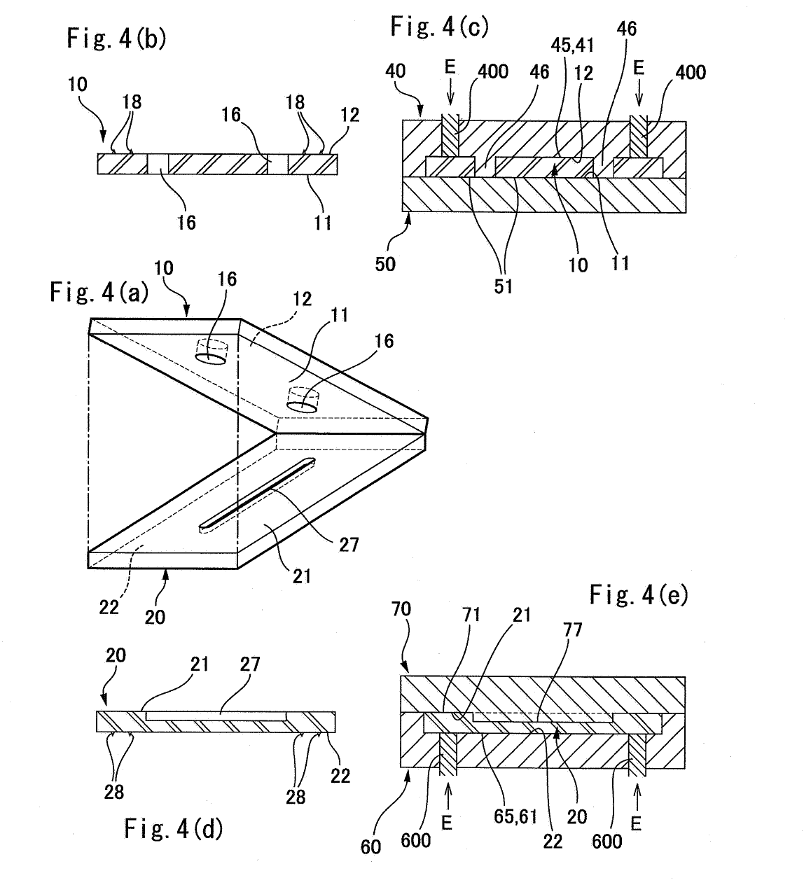

FIG. 4(a) is an explanatory view showing a structure of a resin joining product in accordance with a modified example of the second embodiment of the present invention, FIG. 4(b) is a cross-sectional view showing a first resin member which is used for manufacturing the resin joining product, FIG. 4(c) is an explanatory view showing a molding die which is used for manufacturing the first resin member, FIG. 4(d) is a cross-sectional view showing a second resin member which is used for manufacturing the resin joining product, and FIG. 4(e) is an explanatory view showing a molding die which is used for manufacturing the second resin member.

As shown in FIG. 4(a), similarly to the first embodiment, a resin joining product of this embodiment is manufactured such that, in a molding step, a first resin member 10 and a second resin member 20 which are formed of acrylic plate or the like are molded with a molding die and then, in a joining step, solvent such as propyl alcohol is interposed between an abutting face 11 of the first resin member 10 and an abutting face 21 of the second resin member 20 and, in this state, the first resin member 10 and the second resin member 20 are heated and pressurized. As a result, the resin joining product in this embodiment is obtained by joining the abutting faces 11 and 21 of the first resin member 10 and the second resin member 20 with each other by solvent bonding.

In this embodiment, as shown in FIGS. 4(a), 4(b) and 4(d), the recessed parts comprising of the through holes 16 whose bore diameter is 5 mm are formed in the first resin member 10 and the through holes 16 are opened to the abutting face 11. On the other hand, the abutting face 21 of the second resin member 20 is formed with a recessed part comprising a groove 27 with a width of 200 μm and a depth of 200 μm. Therefore, when the abutting faces 11 and 21 of the first resin member 10 and the second resin member 20 are joined with each other by solvent bonding, a flow path formed of the groove 27 is structured in the joining interface and sample injection ports communicating with the flow path are structured in the first resin member 10 with the through holes 16.

In order to manufacture the resin joining product as described above, in a manufacturing process (molding step) of the first resin member 10, as shown in FIG. 4(c), a molding die provided with a first die member 40 and a second die member 50 are used. The second die member 50 is provided with a flat molding face 51 for molding an abutting face 11 of the first resin member 10. The first die member 40 is provided with a molding face 41 for molding a face 12 on an opposite side to the abutting face 11 of the first resin member 10 on a bottom part of a cavity portion 45. In addition, the molding face 41 of the first die member 40 is formed with bar-shaped high protruded parts 46 for forming the through holes 16.

In accordance with this embodiment, ejection pins 400 are arranged on a side of the first die member 40 and, when the first resin member 10 is to be detached from the first die member 40, the tip end portions of the ejection pins 400 abut with the face 12 on the opposite side to the abutting face 11 of the first resin member 10. Therefore, a burr 18 as shown in FIG. 4(b) may be formed on the first resin member 10 but the burr 18 is formed on the face 12 on the opposite side to the abutting face 11.

Further, in a manufacturing process (molding step) of the second resin member 20, as shown in FIG. 4(e), a molding die provided with a first die member 60 and a second die member 70 are used. The first die member 60 is provided with a flat molding face 61 for molding a face 22 on an opposite side to the abutting face 21 of the second resin member 20 on a bottom part of a cavity portion 65. The second die member 70 is provided with a molding face 71 for molding the abutting face 21 of the second resin member 20. In addition, the molding face 71 of the second die member 70 is formed with a low protruded part 77 for forming the groove 27 which is linearly extended.

In this embodiment, ejection pins 600 are arranged on a side of the first die member 60 and, when the second resin member 20 is to be detached from the first die member 60, tip end portions of the ejection pins 600 abut with the face 22 on the opposite side to the abutting face 21 of the second resin member 20. Therefore, a burr 28 as shown in FIG. 4(d) may be formed on the second resin member 20 but the burr 28 is formed on the face 22 on the opposite side to the abutting face 21.

As described above, in this embodiment, the burrs 18 and 28 are formed on the first resin member 10 and the second resin member 20 but the burrs 18 and 28 are formed on the faces 12 and 22 on the opposite side to the abutting faces 11 and 21. Therefore, a gap space due to the burrs 18 and 28 is not formed between the first resin member 10 and the second resin member 20 and thus the first resin member 10 and the second resin member 20 are surely joined with each other.

### Third Embodiment

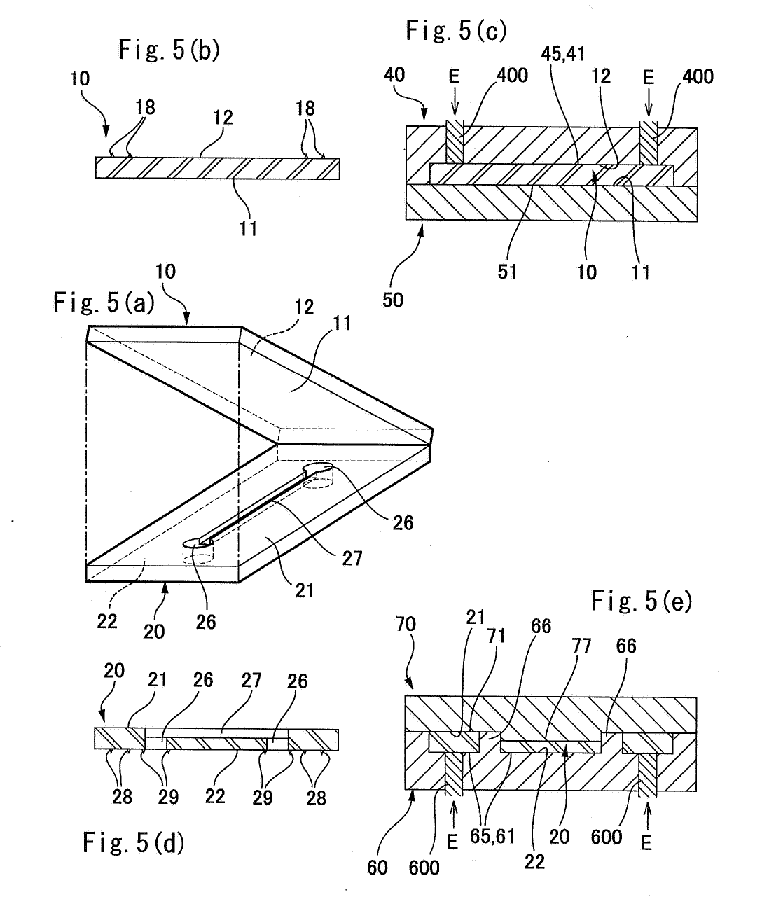

FIG. 5(a) is an explanatory view showing a structure of a resin joining product in accordance with a third embodiment of the present invention, FIG. 5(b) is a cross-sectional view showing a first resin member which is used for manufacturing the resin joining product, FIG. 5(c) is an explanatory view showing a molding die which is used for manufacturing the first resin member, FIG. 5(d) is a cross-sectional view showing a second resin member which is used for manufacturing the resin joining product, and FIG. 5(e) is an explanatory view showing a molding die which is used for manufacturing the second resin member.

As shown in FIG. 5(a), similarly to the first embodiment, a resin joining product of the third embodiment is manufactured such that, in a molding step, a first resin member 10 and a second resin member 20 which are formed of acrylic plate or the like are molded with a die and then, in a joining step, solvent such as propyl alcohol is interposed between an abutting face 11 of the first resin member 10 and an abutting face 21 of the second resin member 20 and, in this state, the first resin member 10 and the second resin member 20 are heated and pressurized. As a result, the resin joining product in the third embodiment is obtained by joining the abutting faces 11 and 21 of the first resin member 10 and the second resin member 20 with each other by solvent bonding.

As shown in FIGS. 5(a), 5(b) and 5(d), the abutting face 11 of the first resin member 10 is a flat surface on which a groove or the like is not formed. On the other hand, the abutting face 21 of the second resin member 20 is formed with a recessed part comprising a groove 27 and through holes 26. Therefore, when the abutting faces 11 and 21 of the first resin member 10 and the second resin member 20 are joined with each other by solvent bonding, a flow path formed of the groove 27 is structured in the joining interface and sample injection ports communicating with the flow path are structured in the second resin member 20 with the through holes 26.

In order to manufacture the resin joining product as described above, in a manufacturing process (molding step) of the first resin member 10, as shown in FIG. 5(c), a molding die provided with a first die member 40 and a second die member 50 are used. The second die member 50 is provided with a flat molding face 51 for molding the abutting face 11 of the first resin member 10. The first die member 40 is provided with a molding face 41 for molding the face 12 on the opposite side to the abutting face 11 of the first resin member 10 on a bottom part of a cavity portion 45.

In accordance with the third embodiment, ejection pins 400 are arranged on a side of the first die member 40 and, when the first resin member 10 is to be detached from the first die member 40, tip end portions of the ejection pins 400 abut with the face 12 on the opposite side to the abutting face 11 of the first resin member 10. Therefore, a burr 18 as shown in FIG. 5(b) may be formed on the first resin member 10 but the burr 18 is formed on the face 12 on the opposite side to the abutting face 11.

Further, in a manufacturing process (molding step) of the second resin member 20, as shown in FIG. 5(e), a molding die provided with a first die member 60 and a second die member 70 are used. The first die member 60 is provided with a molding face 61 for molding a face 22 on an opposite side to the abutting face 21 of the second resin member 20 on a bottom part of a cavity portion 65. The second die member 70 is provided with a molding face 71 for molding the abutting face 21 of the second resin member 20. In addition, the molding face 71 of the second die member 70 is formed with a low protruded part 77 for forming the groove 27 which is linearly extended and the molding face 61 of the first die member 60 is formed with bar-shaped high protruded parts 66 for forming the through holes 26.

In accordance with the third embodiment, ejection pins 600 are arranged on a side of the first die member 60 and, when the second resin member 20 is to be detached from the first die member 60, tip end portions of the ejection pins 600 abut with the face 22 on the opposite to the abutting face 21 of the second resin member 20. Accordingly, a burr 28 as shown in FIG. 5(d) may be formed on the second resin member 20 but the burr 28 is formed on the face 22 on the opposite side to the abutting face 21.

In addition, when the protruded parts 66 are extracted from the through hole 26 of the second resin member 20, burrs 29 may be formed on the extracted side of the second resin member 20 but the burr 29 is formed on the face 22 on the opposite side to the abutting face 21.

As described above, in the third embodiment, the burrs 18, 28 and 29 are formed on the first resin member 10 and the second resin member 20 but the burrs 18, 28 and 29 are formed on the faces 12 and 22 on the opposite side to the abutting faces 11 and 21. Therefore, a gap space due to the burrs 18, 28 and 29 is not formed between the first resin member 10 and the second resin member 20 and thus the first resin member 10 and the second resin member 20 are surely joined with each other.

### Modified Example of the Third Embodiment

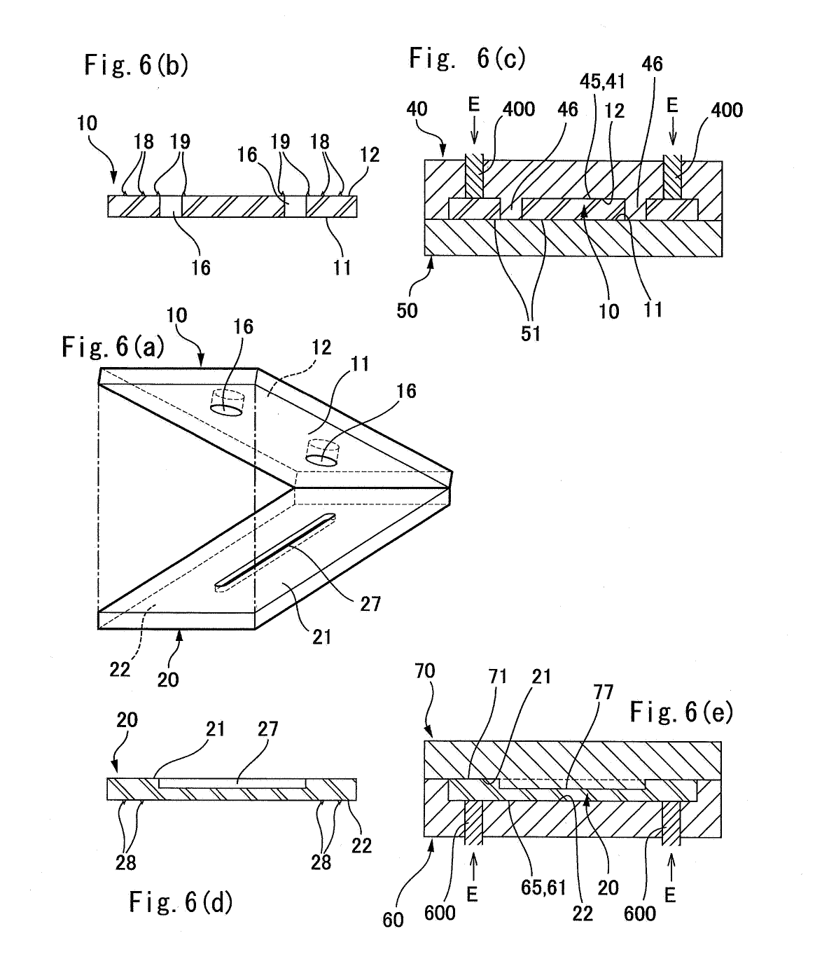

FIG. 6(a) is an explanatory view showing a structure of a resin joining product in accordance with a modified example of the third embodiment of the present invention, FIG. 6(b) is a cross-sectional view showing a first resin member which is used for manufacturing the resin joining product, FIG. 6(c) is an explanatory view showing a molding die which is used for manufacturing the first resin member, FIG. 6(d) is a cross-sectional view showing a second resin member which is used for manufacturing the resin joining product, and FIG. 6(e) is an explanatory view showing a molding die which is used for manufacturing the second resin member.

As shown in FIG. 6(a), similarly to the first embodiment, a resin joining product of this embodiment is manufactured such that, in a molding step, a first resin member 10 and a second resin member 20 which are formed of acrylic plate or the like are molded with a molding die and then, in a joining step, solvent such as propyl alcohol is interposed between an abutting face 11 of the first resin member 10 and an abutting face 21 of the second resin member 20 and, in this state, the first resin member 10 and the second resin member 20 are heated and pressurized. As a result, the resin joining product in this embodiment is obtained by joining the abutting faces 11 and 21 of the first resin member 10 and the second resin member 20 with each other by solvent bonding.

In this embodiment, as shown in FIGS. 6(a), 6(b) and 6(d), the recessed parts comprising of the through holes 16 whose bore diameter is 5 mm are formed in the first resin member 10 and the through holes 16 are opened to the abutting face 11. On the other hand, the abutting face 21 of the second resin member 20 is formed with a recessed part comprising a groove 27 with a width of 200 μm and a depth of 200 μm. Therefore, when the abutting faces 11 and 21 of the first resin member 10 and the second resin member 20 are joined with each other by solvent bonding, a flow path formed of the groove 27 is structured in the joining interface and sample injection ports communicating with the flow path are structured in the first resin member 10 with the through holes 16.

In order to manufacture the resin joining product as described above, in a manufacturing process (molding step) of the first resin member 10, as shown in FIG. 6(c), a molding die provided with a first die member 40 and a second die member 50 are used. The second die member 50 is provided with a flat molding face 51 for molding an abutting face 11 of the first resin member 10. The first die member 40 is provided with a molding face 41 for molding a face 12 on an opposite side to the abutting face 11 of the first resin member 10 on a bottom part of a cavity portion 45. In addition, the molding face 41 of the first die member 40 is formed with bar-shaped high protruded parts 46 for forming the through holes 16.

In accordance with this embodiment, ejection pins 400 are arranged on a side of the first die member 40 and, when the first resin member 10 is to be detached from the first die member 40, the tip end portions of the ejection pins 400 abut with the face 12 on the opposite side to the abutting face 11 of the first resin member 10. Therefore, a burr 18 as shown in FIG. 6(b) may be formed on the first resin member 10 but the burr 18 is formed on the face 12 on the opposite side to the abutting face 11.

In addition, when the protruded parts 46 are extracted from the through hole 16 of the first resin member 10, burrs 19 may be formed on the extracted side of the first resin member 10 but the burr 19 is also formed on the face 12 on the opposite side to the abutting face 11.

Further, in a manufacturing process (molding step) of the second resin member 20, as shown in FIG. 6(e), a molding die provided with a first die member 60 and a second die member 70 are used. The first die member 60 is provided with a flat molding face 61 for molding a face 22 on an opposite side to the abutting face 21 of the second resin member 20 on a bottom part of a cavity portion 65. The second die member 70 is provided with a molding face 71 for molding the abutting face 21 of the second resin member 20. In addition, the molding face 71 of the second die member 70 is formed with a low protruded part 77 for forming the groove 27 which is linearly extended.

In this embodiment, ejection pins 600 are arranged on a side of the first die member 60 and, when the second resin member 20 is to be detached from the first die member 60, tip end portions of the ejection pins 600 abut with the face 22 on the opposite side to the abutting face 21 of the second resin member 20. Therefore, a burr 28 as shown in FIG. 6(d) may be formed on the second resin member 20 but the burr 28 is formed on the face 22 on the opposite side to the abutting face 21.

As described above, in this embodiment, the burrs 18, 19 and 28 are formed on the first resin member 10 and the second resin member 20 but the burrs 18, 19 and 28 are formed on the faces 12 and 22 on the opposite side to the abutting faces 11 and 21. Therefore, a gap space due to the burrs 18, 19 and 28 is not formed between the first resin member 10 and the second resin member 20 and thus the first resin member 10 and the second resin member 20 are surely joined with each other.

### Fourth Embodiment

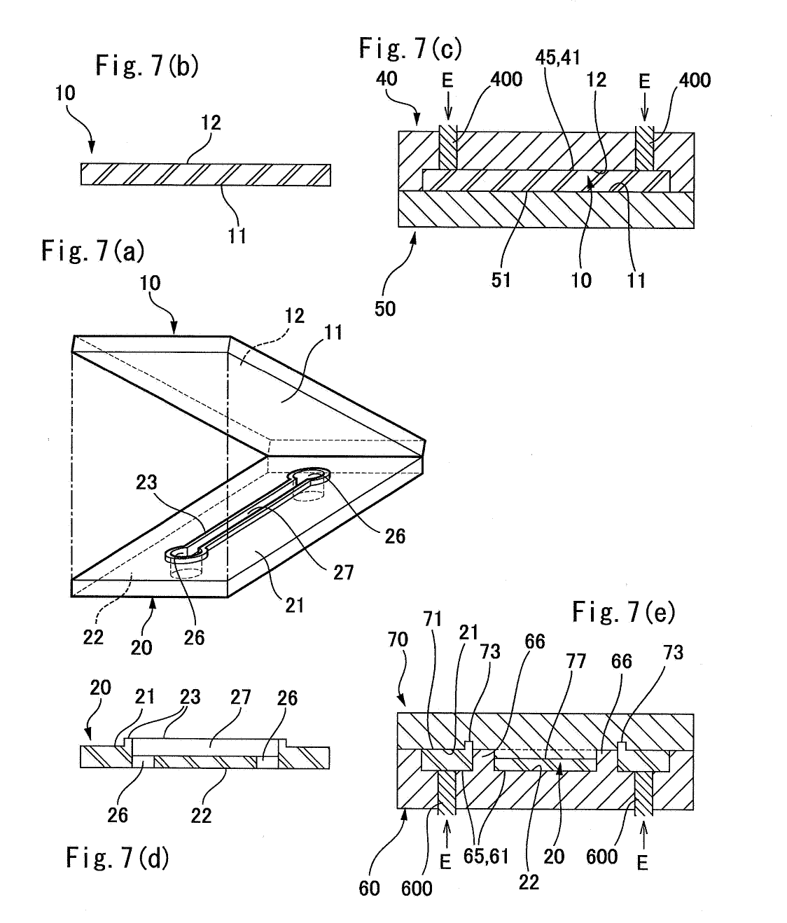

FIG. 7(a) is an explanatory view showing a structure of a resin joining product in accordance with a fourth embodiment of the present invention, FIG. 7(b) is a cross-sectional view showing a first resin member which is used for manufacturing the resin joining product, FIG. 7(c) is an explanatory view showing a molding die which is used for manufacturing the first resin member, FIG. 7(d) is a cross-sectional view showing a second resin member which is used for manufacturing the resin joining product, and FIG. 7(e) is an explanatory view showing a molding die which is used for manufacturing the second resin member.

As shown in FIG. 7(a), similarly to the first embodiment, a resin joining product of the fourth embodiment is manufactured such that, in a molding step, a first resin member 10 and a second resin member 20 which are formed of acrylic plate or the like are molded with a molding die and then, in a joining step, solvent such as propyl alcohol is interposed between an abutting face 11 of the first resin member 10 and an abutting face 21 of the second resin member 20 and, in this state, the first resin member 10 and the second resin member 20 are heated and pressurized. As a result, the resin joining product in the fourth embodiment is obtained by joining the abutting faces 11 and 21 of the first resin member 10 and the second resin member 20 with each other by solvent bonding.

As shown in FIGS. 7(a), 7(b) and 7(d), the abutting face 11 of the first resin member 10 is a flat surface on which a groove or the like is not formed. On the other hand, the abutting face 21 of the second resin member 20 is formed with a recessed part comprising a groove 27 and through holes 26. Therefore, when the abutting faces 11 and 21 of the first resin member 10 and the second resin member 20 are joined with each other by solvent bonding, a flow path formed of the groove 27 is structured in the joining interface and sample injection ports communicating with the flow path are structured in the second resin member 20 with the through holes 26.

In order to manufacture the resin joining product as described above, in a manufacturing process (molding step) of the first resin member 10, as shown in FIG. 7(c), a molding die provided with a first die member 40 and a second die member 50 are used. The second die member 50 is provided with a flat molding face 51 for molding the abutting face 11 of the first resin member 10. The first die member 40 is provided with a molding face 41 for molding the face 12 on the opposite side to the abutting face 11 of the first resin member 10 on a bottom part of a cavity portion 45. In accordance with the fourth embodiment, ejection pins 400 are arranged on a side of the first die member 40 and, when the first resin member 10 is to be detached from the first die member 40, tip end portions of the ejection pins 400 abut with the face 12 on the opposite side to the abutting face 11 of the first resin member 10.

Further, in a manufacturing process (molding step) of the second resin member 20, as shown in FIG. 7(e), a molding die provided with a first die member 60 and a second die member 70 are used. The first die member 60 is provided with a molding face 61 for molding a face 22 on an opposite side to the abutting face 21 of the second resin member 20 on a bottom part of a cavity portion 65. The second die member 70 is provided with a molding face 71 for molding the abutting face 21 of the second resin member 20. In addition, the molding face 71 of the second die member 70 is formed with a low protruded part 77 for forming the groove 27 which is linearly extended and the molding face 61 of the first die member 60 is formed with bar-shaped high protruded parts 66 for forming the through holes 26. In accordance with the fourth embodiment, ejection pins 600 are arranged on a side of the first die member 60 and, when the second resin member 20 is to be detached from the first die member 60, tip end portions of the ejection pins 600 abut with the face 22 on the opposite to the abutting face 21 of the second resin member 20.

In addition, in this embodiment, a groove 73 is formed on the molding face 71 of the second die member 70 for forming a protruded part 23 at a position surrounding the recessed part comprising of the groove 27 and the through holes 26 shown in FIGS. 7(a) and 7(d) in the second resin member 20.

Therefore, in this embodiment, in a case that the abutting faces 11 and 21 of the first resin member 10 and the second resin member 20 are overlapped with each other, even when a burr is formed on the abutting faces 11 and 21 of the first resin member 10 and the second resin member 20, the first resin member 10 and the second resin member 20 are surely contacted with each other through the protruded part 23. Therefore, the first resin member 10 and the second resin member 20 are joined with each other surely through the protruded part 23. In this case, the abutting face 21 of the second resin member 20 means a face on an abutting side and the real abutting face of the second resin member 20 is an upper face of the protruded part 23. In this embodiment, a gap space due to the protruded part 23 is formed between the first resin member 10 and the second resin member 20. However, the protruded part 23 is formed to surround the groove 27 and the through holes 26 and thus liquid does not leak out from the flow path formed with the groove 27.

Further, in this embodiment, the burrs 18, 28 and 29 (see FIGS. 5(b) and 5(d)) as described in the third embodiment are formed but the burrs 18, 28 and 29 are formed on the faces 12 and 22 on the opposite side to the abutting faces 11 and 21. Therefore, a gap space due to the burrs 18, 28 and 29 is not formed between the first resin member 10 and the second resin member 20 and thus the first resin member 10 and the second resin member 20 are surely joined with each other.

In addition, in this embodiment, even when the burrs are formed on the abutting faces 11 and 21, the first resin member 10 and the second resin member 20 are surely contacted with each other through the protruded part 23. Therefore, even when the burrs 18, 28 and 29 as described with reference to FIGS. 5(b) and 5(d) are formed on the abutting faces 11 and 21, the first resin member 10 and the second resin member 20 are surely joined with each other through the protruded part 23. Therefore, liquid does not leak out from the flow path formed with the groove 27.

### Modified Example of the Fourth Embodiment

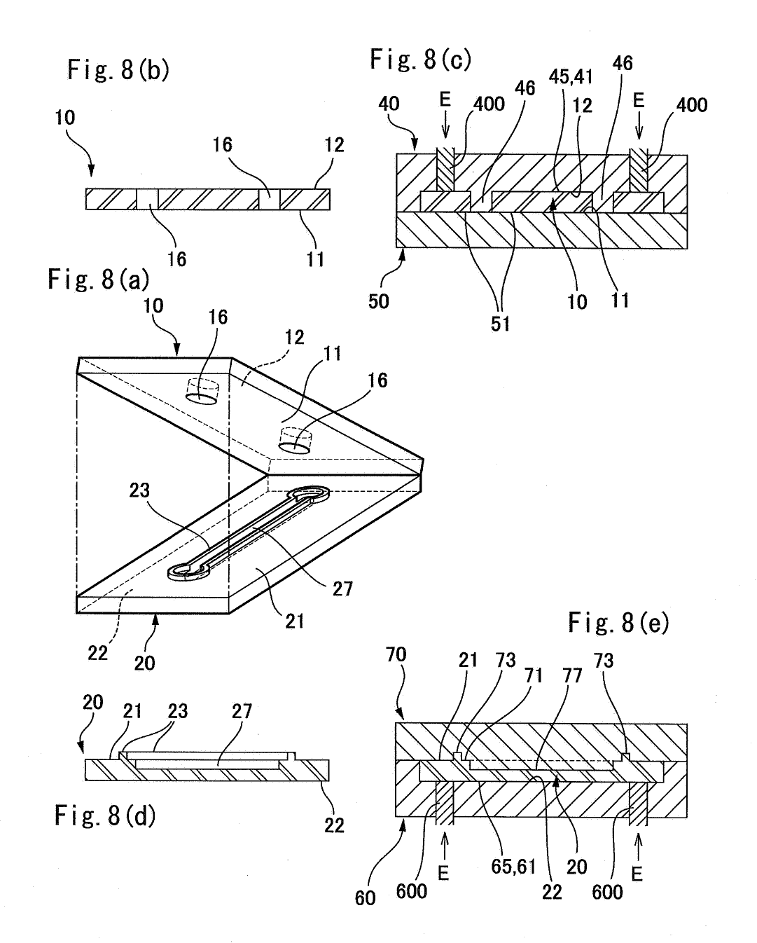

FIG. 8(a) is an explanatory view showing a structure of a resin joining product in accordance with a modified example of the fourth embodiment of the present invention, FIG. 8(b) is a cross-sectional view showing a first resin member used for manufacturing of this resin joining product, FIG. 8(c) is an explanatory view showing a molding die which is used for manufacturing the first resin member, FIG. 8(d) is an cross-sectional view showing a second resin member which is used for manufacturing the resin joining product, and FIG. 8(e) is an explanatory view showing a molding die which is used for manufacturing the second resin member.

As shown in FIG. 8(a), similarly to the first embodiment, a resin joining product of this embodiment is manufactured such that, in a molding step, a first resin member 10 and a second resin member 20 which are formed of acrylic plate or the like are molded with a molding die and then, in a joining step, solvent such as propyl alcohol is interposed between an abutting face 11 of the first resin member 10 and an abutting face 21 of the second resin member 20 and, in this state, the first resin member 10 and the second resin member 20 are heated and pressurized. As a result, the resin joining product in this embodiment is obtained by joining the abutting faces 11 and 21 of the first resin member 10 and the second resin member 20 with each other by solvent bonding. In this embodiment, strictly speaking, the abutting face 21 is not an abutting face which abuts with the abutting face 11, but the word “abutting face 21” is used to simplify its description.

In this embodiment, as shown in FIGS. 8(a), 8(b) and 8(d), the recessed parts comprising of the through holes 16 whose bore diameter is 5mm are formed in the first resin member 10 and the through holes 16 are opened to the abutting face 11. On the other hand, the abutting face 21 of the second resin member 20 is formed with a recessed part comprising a groove 27 with a width of 200 μm and a depth of 200 μm. Therefore, when the abutting faces 11 and 21 of the first resin member 10 and the second resin member 20 are joined with each other by solvent bonding, a flow path formed of the groove 27 is structured in the joining interface and sample injection ports communicating with the flow path are structured in the first resin member 10 with the through holes 16.

In order to manufacture the resin joining product as described above, in a manufacturing process (molding step) of the first resin member 10, as shown in FIG. 8(c), a molding die provided with a first die member 40 and a second die member 50 are used. The second die member 50 is provided with a flat molding face 51 for molding an abutting face 11 of the first resin member 10. The first die member 40 is provided with a molding face 41 for molding a face 12 on an opposite side to the abutting face 11 of the first resin member 10 on a bottom part of a cavity portion 45. In addition, the molding face 41 of the first die member 40 is formed with bar-shaped high protruded parts 46 for forming the through holes 16. In accordance with this embodiment, ejection pins 400 are arranged on a side of the first die member 40 and, when the first resin member 10 is to be detached from the first die member 40, the tip end portions of the ejection pins 400 abut with the face 12 on the opposite side to the abutting face 11 of the first resin member 10.

Further, in a manufacturing process (molding step) of the second resin member 20, as shown in FIG. 8(e), a molding die provided with a first die member 60 and a second die member 70 are used. The first die member 60 is provided with a flat molding face 61 for molding a face 22 on an opposite side to the abutting face 21 of the second resin member 20 on a bottom part of a cavity portion 65. The second die member 70 is provided with a molding face 71 for molding the abutting face 21 of the second resin member 20. In addition, the molding face 71 of the second die member 70 is formed with a low protruded part 77 for forming the groove 27 which is linearly extended. In this embodiment, ejection pins 600 are arranged on a side of the first die member 60 and, when the second resin member 20 is to be detached from the first die member 60, tip end portions of the ejection pins 600 abut with the face 22 on the opposite side to the abutting face 21 of the second resin member 20.

In addition, in this embodiment, a groove 73 is formed on the molding face 71 of the second die member 70 for forming a protruded part 23 at a position capable of surrounding the through holes 16 shown in FIGS. 8(a) and 8(b) and at a position surrounding the groove 27 shown in FIGS. 8(a) and 8(d) of the second resin member 20.

Therefore, in this embodiment, in a case that the abutting faces 11 and 21 of the first resin member 10 and the second resin member 20 are overlapped with each other, even when a burr is formed on the abutting faces 11 and 21 of the first resin member 10 and the second resin member 20, the first resin member 10 and the second resin member 20 are surely contacted with each other through the protruded part 23. Therefore, the first resin member 10 and the second resin member 20 are joined with each other surely through the protruded part 23. In this case, the abutting face 21 of the second resin member 20 means a face on an abutting side and the real abutting face of the second resin member 20 is the upper face of the protruded part 23. In this embodiment, a gap space due to the protruded part 23 is formed between the first resin member 10 and the second resin member 20. However, the protruded part 23 is formed to surround the groove 27 and the through holes 26 and thus liquid does not leak out from the flow path formed with the groove 27.

Further, in this embodiment, the burrs 18, 19 and 28 (see FIGS. 6(b) and 6(d)) as described in the modified example of the third embodiment are formed but the burrs 18, 19 and 28 are formed on the faces 12 and 22 on the opposite side to the abutting faces 11 and 21. Therefore, a gap space due to the burrs 18, 19 and 28 is not formed between the first resin member 10 and the second resin member 20 and thus the first resin member 10 and the second resin member 20 are surely joined with each other.

In addition, in this embodiment, even when the burrs are formed on the abutting faces 11 and 21, the first resin member 10 and the second resin member 20 are surely contacted with each other through the protruded part 23. Therefore, even when the burrs 18, 19 and 28 as described with reference to FIGS. 6(b) and 6(d) are formed on the abutting faces 11 and 21, the first resin member 10 and the second resin member 20 are surely joined with each other through the protruded part 23. Therefore, liquid does not leak out from the flow path formed with the groove 27.

### Another Modified Example of the Fourth Embodiment

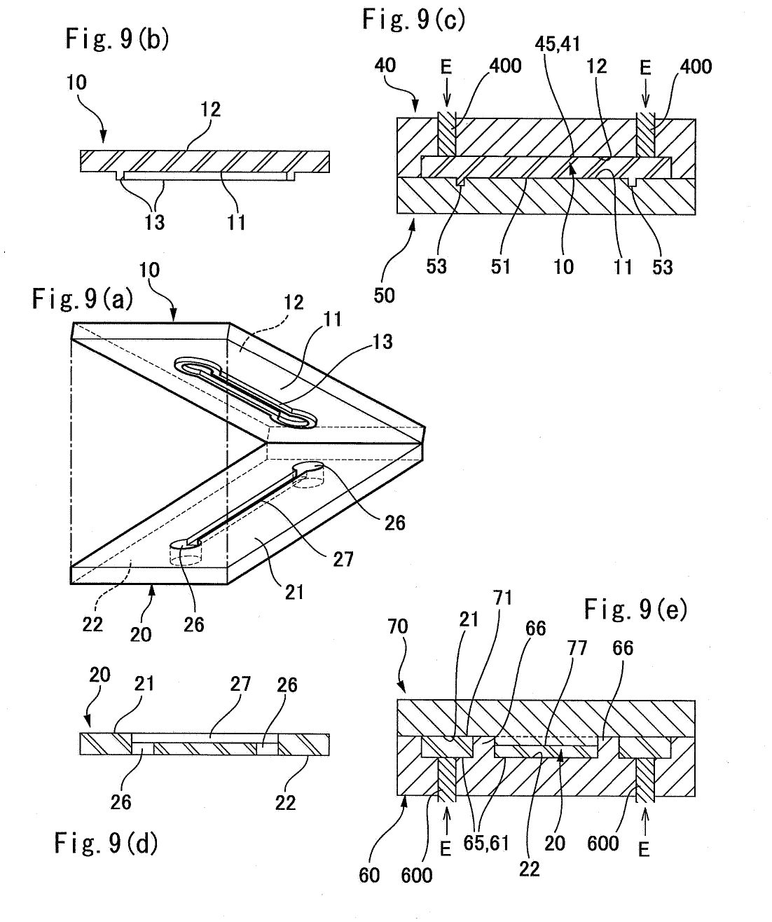

FIG. 9(a) is an explanatory view showing a structure of a resin joining product in accordance with another modified example of the fourth embodiment of the present invention, FIG. 9(b) is a cross-sectional view showing a first resin member which is used for manufacturing the resin joining product, FIG. 9(c) is an explanatory view showing a molding die which is used for manufacturing the first resin member, FIG. 9(d) is a cross-sectional view showing a second resin member which is used for manufacturing the resin joining product, and FIG. 9(e) is an explanatory view showing a molding die which is used for manufacturing the second resin member.

In the above-mentioned embodiment described with reference to FIGS. 7(a) through 7(e), the groove 73 is formed on the molding face 71 of the second die member 70 for forming the protruded part 23 at a position surrounding the groove 27 and the through holes 26 shown in FIGS. 7(a) and 7(d) in the second resin member 20. However, in this embodiment, as shown in FIGS. 9(a) through 9(e), a groove 53 is formed on a molding face 51 of the second die member 50 for forming a protruded part 13 at a position capable of surrounding a groove 27 and through holes 26 of the second resin member 20. In this embodiment, strictly speaking, the abutting face 11 is not an abutting face which abuts with the abutting face 21, but the word “abutting face 11” is used to simplify its description. Also in this case structured as described above, when the abutting faces 11 and 21 of the first resin member 10 and the second resin member 20 are overlapped with each other, the first resin member 10 and the second resin member 20 are surely contacted with each other through the protruded part 13 even when a burr is formed on the abutting faces 11 and 21 of the first resin member 10 and the second resin member 20. Therefore, the first resin member 10 and the second resin member 20 are joined with each other surely through the protruded part 13 and thus similar effects to the fourth embodiment can be obtained. In this embodiment, a gap space due to the protruded part 13 is formed between the first resin member 10 and the second resin member 20. However, the protruded part 13 is formed to surround the groove 27 and the through holes 26 and thus liquid does not leak out from the flow path formed with the groove 27.

### Another Modified Example of the Fourth Embodiment

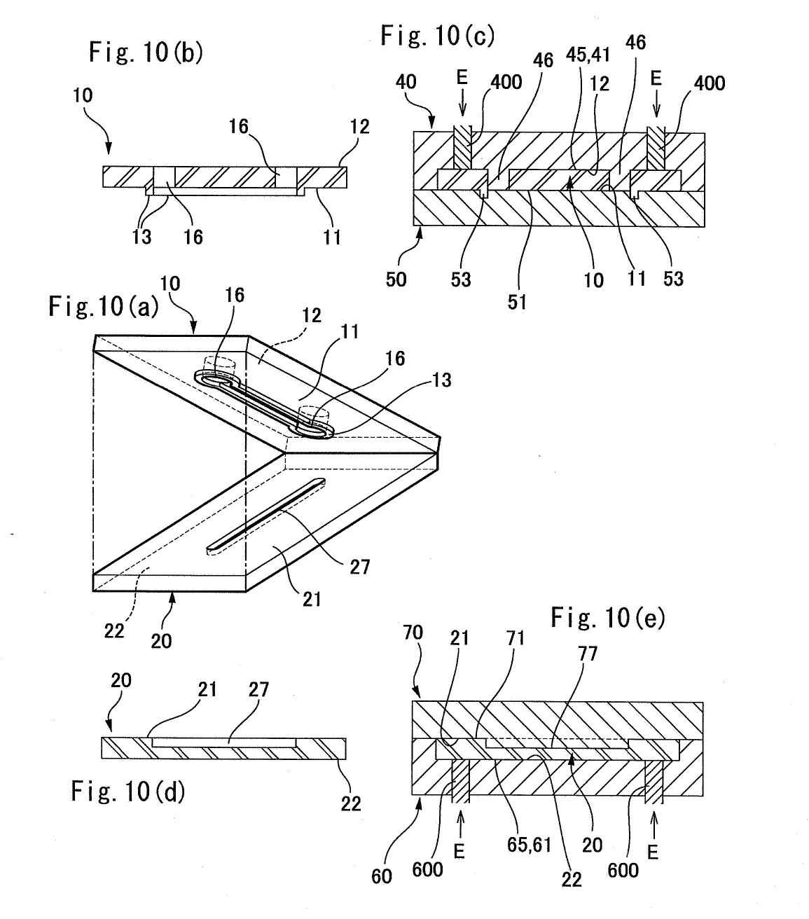

FIG. 10(a) is an explanatory view showing a structure of a resin joining product in accordance with further another modified example of the fourth embodiment of the present invention, FIG. 10(b) is a cross-sectional view showing a first resin member which is used for manufacturing the resin joining product, FIG. 10(c) is an explanatory view showing a molding die which is used for manufacturing the first resin member, FIG. 10(d) is a cross-sectional view showing a second resin member which is used for manufacturing the resin joining product, and FIG. 10(e) is an explanatory view showing a molding die which is used for manufacturing the second resin member.

In the embodiment described with reference to FIGS. 8(a) through 8(e), the groove 73 is formed on the molding face 71 of the second die member 70 for forming the protruded part 23 at a position surrounding the groove 27 and the through holes 26 shown in FIGS. 7(a) and 7(d) in the second resin member 20. However, in this embodiment, as shown in FIGS. 10(a) through 10(e), a groove 53 is formed on a molding face 51 of the second die member 50 for forming a protruded part 13 at a position capable of surrounding a groove 27 of the second resin member 20 and at a position surrounding through holes 26 of the first resin member 10. In this embodiment, the abutting face 11 is not an abutting face which abuts with the abutting face 21, but the word “abutting face 11” is used to simplify its description. Also in this case structured as described above, when the abutting faces 11 and 21 of the first resin member 10 and the second resin member 20 are overlapped with each other, the first resin member 10 and the second resin member 20 are surely contacted with each other through the protruded part 13 even when a burr is formed on the abutting faces 11 and 21. Therefore, the first resin member 10 and the second resin member 20 are joined with each other surely through the protruded part 13 and thus similar effects to the fourth embodiment can be obtained. In this embodiment, a gap space due to the protruded part 13 is formed between the first resin member 10 and the second resin member 20. However, the protruded part 13 is formed to surround the groove 27 and the through holes 26 and thus liquid does not leak out from the flow path formed with the groove 27.

### Another Modified Example of the Fourth Embodiment

In the fourth embodiment and its modified examples, the protruded part 13 and 23 are formed so as to surround the groove 27 and the through holes 16 which are formed in at least one of the abutting faces 11 and 21 of the first resin member 10 and the second resin member 20. However, it may be structured such that the height of the protruded part 13 or 23 is set to be higher than the case of the fourth embodiment and its modified examples to form the recessed part by the protruded part 13 or by the protruded part 23 and a flow path is formed between the abutting faces 11 and 21 of the first resin member 10 and the second resin member 20. According to the structure as described above, a step for forming the groove 27 in the first resin member 10 or the second resin member 20 can be omitted.

### Fifth Embodiment

In the fourth embodiment and its modified examples, the groove for forming the protruded parts 13 and 23 is formed on a die member. However, as described below, a protruded part 23 may be formed in the second resin member 20 by utilizing a burr which is formed at the time of die molding.

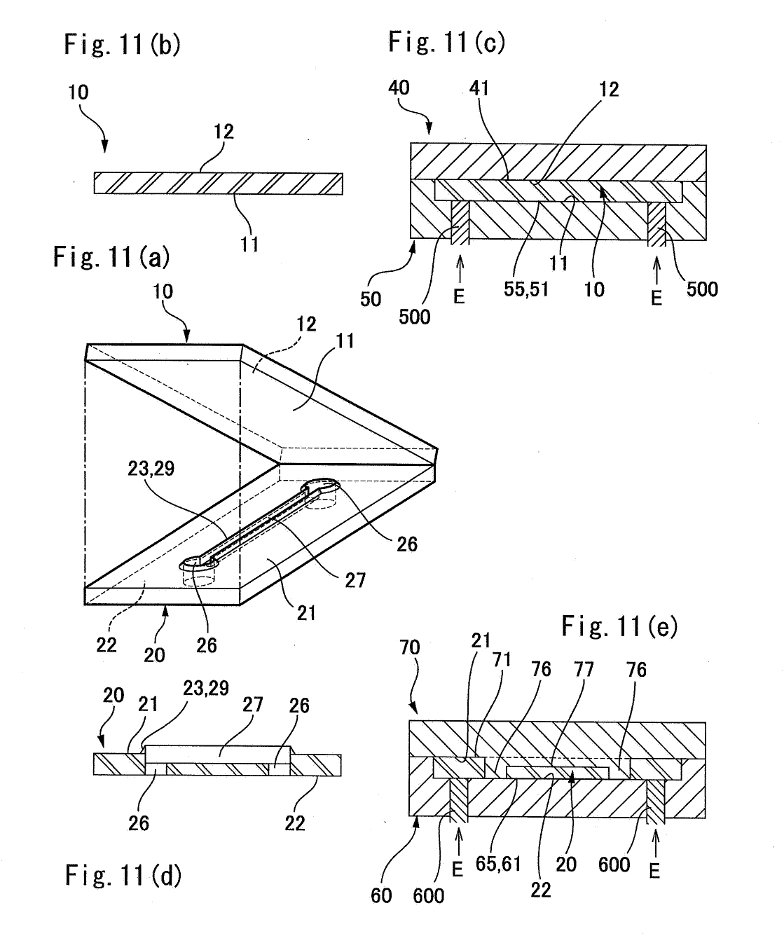

FIG. 11(a) is an explanatory view showing a structure of a resin joining product in accordance with a fifth embodiment of the present invention, FIG. 11(b) is a cross-sectional view showing a first resin member which is used for manufacturing the resin joining product, FIG. 11(c) is an explanatory view showing a molding die which is used for manufacturing the first resin member, FIG. 11(d) is a cross-sectional view showing a second resin member which is used for manufacturing the resin joining product, and FIG. 11(e) is an explanatory view showing a molding die which is used for manufacturing the second resin member.

As shown in FIG. 11(a), similarly to the first embodiment, a resin joining product of this embodiment is manufactured such that, in a molding step, a first resin member 10 and a second resin member 20 which are formed of acrylic plate or the like are molded with a molding die and then, in a joining step, solvent such as propyl alcohol is interposed between an abutting face 11 of the first resin member 10 and an abutting face 21 of the second resin member 20 and, in this state, the first resin member 10 and the second resin member 20 are heated and pressurized. As a result, the resin joining product in this embodiment is obtained by joining the abutting faces 11 and 21 of the first resin member 10 and the second resin member 20 with each other by solvent bonding.

As shown in FIGS. 11(a), 11(b) and 11(d), the abutting face 11 of the first resin member 10 is a flat surface on which a groove or the like is not formed. On the other hand, the abutting face 21 of the second resin member 20 is formed with a recessed part comprising a groove 27 and through holes 26. Therefore, when the abutting faces 11 and 21 of the first resin member 10 and the second resin member 20 are joined with each other by solvent bonding, a flow path is structured in the joining interface with the groove 27 and sample injection ports communicating with the flow path are structured in the second resin member 20 with the through holes 26.

In order to manufacture the resin joining product as described above, in a manufacturing process (molding step) of the first resin member 10, as shown in FIG. 11(c), a molding die provided with a first die member 40 and a second die member 50 are used. The first die member 40 is provided with a flat molding face 41 for molding a face 12 on an opposite side to the abutting face 11 of the first resin member 10. The second die member 50 is provided with a molding face 51 for molding the abutting face 11 of the first resin member 10 on a bottom part of a cavity portion 55. In accordance with this embodiment, ejection pins 500 are arranged on a side of the second die member 50.

Further, in a manufacturing process (molding step) of the second resin member 20, as shown in FIG. 11(e), a molding die provided with a first die member 60 and a second die member 70 are used. The first die member 60 is provided with a molding face 61 for molding a face 22 on an opposite side to the abutting face 21 of the second resin member 20 on a bottom part of a cavity portion 65. The second die member 70 is provided with a molding face 71 for molding the abutting face 21 of the second resin member 20. In addition, the molding face 71 of the second die member 70 is formed with a low protruded part 77 for forming the groove 27 which is linearly extended and bar-shaped high protruded parts 76 for forming the through holes 26. In accordance with the fourth embodiment, ejection pins 600 are arranged on a side of the first die member 60.

According to the structure as described above, when the protruded parts 76 are extracted from the through holes 26 of the second resin member 20 and the protruded part 77 is extracted from the groove 27, a burr 29 is formed on the extracted side. Therefore, the burr 29 is positively utilized and formed at a position so as to surround around the groove 27 and the through holes 26. As a result, the burr 29 is formed to surround around the groove 27 and the through holes 26 so as to structure the protruded part 23 which is described with reference to FIGS. 7(a) and 7(d). Therefore, in this embodiment, when the abutting faces 11 and 21 of the first resin member 10 and the second resin member 20 are overlapped with each other, the first resin member 10 and the second resin member 20 are surely contacted with each other through the protruded part 23 or the burr 29 even when a burr due to ejection pins 500 is formed on the first resin member 10. Accordingly, the first resin member 10 and the second resin member 20 are surely joined with each other through the protruded part 23. In this embodiment, a gap space due to the protruded part 23 or the burr 29 is formed between the first resin member 10 and the second resin member 20. However, the protruded part 23 or the burr 29 is formed to surround the groove 27 and the through holes 26 and thus liquid does not leak out from the flow path formed with the groove 27.

### Other Embodiments

In the manufacturing method for a resin joining product in accordance with the above-mentioned embodiments, two pieces of resin members are joined with each other. However, the present invention may be applied to a case where three or more pieces of resin members are overlapped and joined with together. In addition, in the above-mentioned embodiment, a plate-shaped resin member is used. However, the present invention may be applied to joining of block-shaped resin members with each other or of film-shaped resin members with each other whose thickness is thin. In addition, alcohols, ketones and hydrocarbon system may be used as solvent which is used for solvent bonding. In addition, solvent bonding is utilized in the embodiment described above, but the present invention may be applied to cases where a method such as joining with an adhesive or thermo compression bonding is utilized.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A manufacturing method for a resin joining product comprising the steps of:
a molding step in which a first resin member and a second resin member are respectively formed with a molding die;
a joining step in which an abutting face of the first resin member and an abutting face of the second resin member are joined with each other;
in the molding step, providing a molding face of a die member of the molding die for forming at least one of the abutting faces of the first resin member and the second resin member with a protruded part for forming a recessed part on the abutting face; and
providing an ejection pin located at a position within an area of the protruded part.

2. The manufacturing method for a resin joining product according to claim 1, wherein the protruded part for forming the recessed part is formed with a height so as to be capable of accommodating a burr which is formed with the ejection pin.

3. The manufacturing method for a resin joining product according to claim 1, wherein in the joining step, solvent is interposed between the first resin member and the second resin member, and then the first resin member and the second resin member are pressed with each other.

4. A molding die for manufacturing a first resin member having an abutting face and a second resin member having an abutting face, in which both the abutting faces are joined with each other to manufacture a resin joining product, comprising:
a molding face of the molding die for forming one of the abutting faces, which is provided with a protruded part for forming a recessed part on the one of the abutting faces; and
an ejection pin which is located at a position within the protruded part.

5. The molding die according to claim 4, wherein the protruded part for forming the recessed part is formed with a height so as to be capable of accommodating a burr which is formed with the ejection pin.

6. A manufacturing method for a resin joining product comprising the steps of:
a molding step in which a first resin member and a second resin member are respectively formed with a molding die;
a joining step in which an abutting face of the first resin member and an abutting face of the second resin member are joined with each other; and
in the molding step, providing an ejection pin located on a side of a die member of the molding die for forming a face on an opposite side to the abutting face of the first resin member or the second resin member.

7. The manufacturing method for a resin joining product according to claim 6, wherein in the joining step, solvent is interposed between the first resin member and the second resin member, and the first resin member and the second resin member are pressed with each other.

8. A molding die for manufacturing a first resin member having an abutting face and a second resin member having an abutting face, in which both the abutting faces are joined with each other to manufacture a resin joining product, comprising:
an ejection pin which is located on a molding face side for forming a face on an opposite side to the abutting face.

9. A manufacturing method for a resin joining product comprising the steps of:
a molding step in which a first resin member having an abutting face and a second resin member having an abutting face are respectively formed with a molding die, and in which a through hole that is opened to the abutting face of the first resin member or the second resin member is formed with the molding die;
a joining step in which an abutting face of the first resin member and an abutting face of the second resin member are joined with each other; and
in the molding step, providing a die member of the molding die with a protruded part for forming the through hole on a molding face for forming a face on an opposite side to the abutting face.

10. The manufacturing method for a resin joining product according to claim 9, wherein in the joining step, solvent is interposed between the first resin member and the second resin member, and the first resin member and the second resin member are pressed with each other.

11. A molding die for manufacturing a first resin member having an abutting face and a second resin member having an abutting face, in which the first resin member or the second resin member is formed with a through hole that is opened to the abutting face of the first resin member or the second resin member, and in which both the abutting faces are joined with each other to manufacture a resin joining product, comprising:
a die member which is provided with a protruded part for forming the through hole on a molding face for forming a face on an opposite side to the abutting face.

12. A manufacturing method for a resin joining product comprising the steps of:
a molding step in which a first resin member and a second resin member are respectively formed with a molding die;
a joining step in which an abutting face of the first resin member and an abutting face of the second resin member are joined with each other;
in the molding step, providing a recessed part comprising a groove and/or through holes formed on the abutting face of at least one of the first resin member and the second resin member; and
in the molding step, providing a protruded part surrounding the recessed part being formed on the one of the first resin member and the second resin member, or a protruded part surrounding an area which overlaps the recessed part being formed on the other of the first resin member and the second resin member.

13. The manufacturing method for a resin joining product according to claim 12, wherein in the joining step, solvent is interposed between the first resin member and the second resin member, and the first resin member and the second resin member are pressed with each other.

14. The manufacturing method for a resin joining product according to claim 12, wherein in the molding step, the protruded part is formed by using a groove formed on a molding face of the molding die.

15. The manufacturing method for a resin joining product according to claim 12, wherein the protruded part is formed of a burr that is formed in the molding step.

16. A molding die for manufacturing a first resin member having an abutting face and a second resin member having an abutting face, in which both the abutting faces are joined to each other to manufacture a resin joining product, comprising:
a first die member being provided with a protruded part for forming a recessed part comprising of a groove and/or through holes on the abutting face of at least one of the first resin member and the second resin member; and
said first die member being provided with a groove surrounding the protruded part for forming the recessed part, or a second die member being provided with a groove surrounding an area which overlaps the recessed part on the abutting face that is formed by the protruded part of the first die member.

17. A molding die for manufacturing a first resin member having an abutting face and a second resin member having an abutting face, in which both the abutting faces are joined with each other to manufacture a resin joining product, comprising:
a first die member being provided with a protruded part for forming a recessed part comprising of a groove and/or through holes on the abutting face of at least one of the first resin member and the second resin member; and
said first die member being structured so that a burr is formed in a protruded shape so as to surround the recessed part, or a second die member being structured so that a burr is formed in a protruded shape so as to surround an area which overlaps the recessed part on the abutting face that is formed by the protruded part of the first die member.

18. A resin joining product which is manufactured by the method as set forth in claim 1.

19. A resin joining product which is manufactured by the method as set forth in claim 6.

20. A resin joining product which is manufactured by the method as set forth in claim 9.

21. A resin joining product which is manufactured by the method as set forth in claim 12.
